(19) United States
(12) Patent Application Publication
(10) Pub. No.: US 2003/0208950 A1
(43) Pub. Date: Nov. 13, 2003

(54) Mongoose

(76) Inventor: Joseph M. Shope, Utica, IN (US)

Correspondence Address: Joseph M. Shope, 115 Fifth Street, Utica, IN, 47130, US

(21) Appl. No.: 10/142,745

(22) Filed: May 10, 2002

(51) Int. Cl. A01M 23/34

(52) U.S. Cl. 43/87

(57) ABSTRACT

The Mongoose is intended to aid Police Officers by meeting the additional task of catching reptiles and animals in a convenient multi-purpose safety baton. Law Enforcement Officers encounter many obstacles on a daily basis, and thus must wear many hats. This tool will aid them in their personal safety, as well as the safety of others at the scene. It is not intended to turn police into animal control, however it provides a safe alternative to capturing animals/reptiles that pose a threat. It will also help the Police with public relations pertaining to animal rights, as this is a non-lethal alternative.

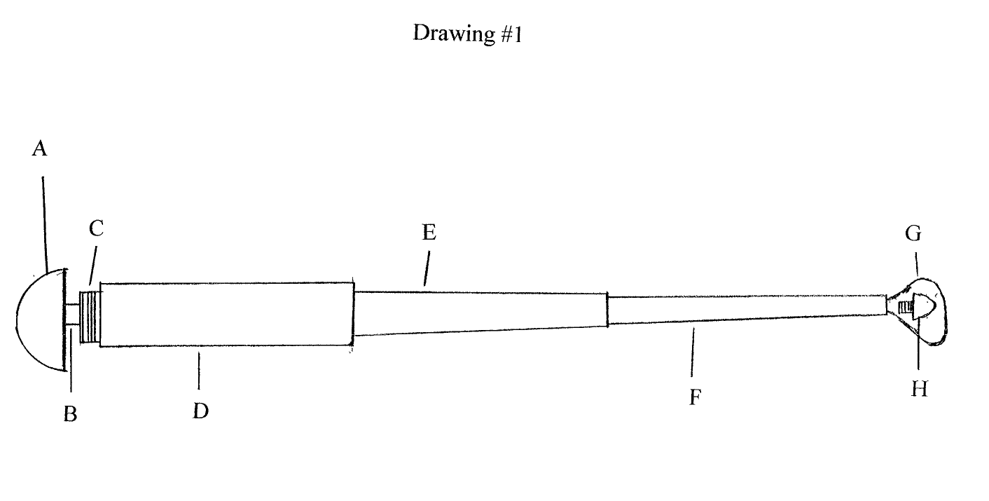

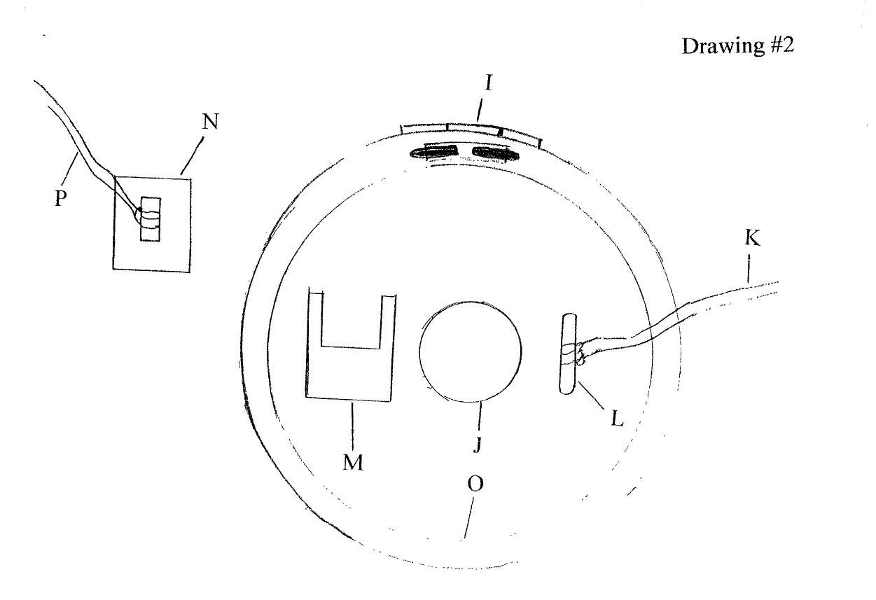

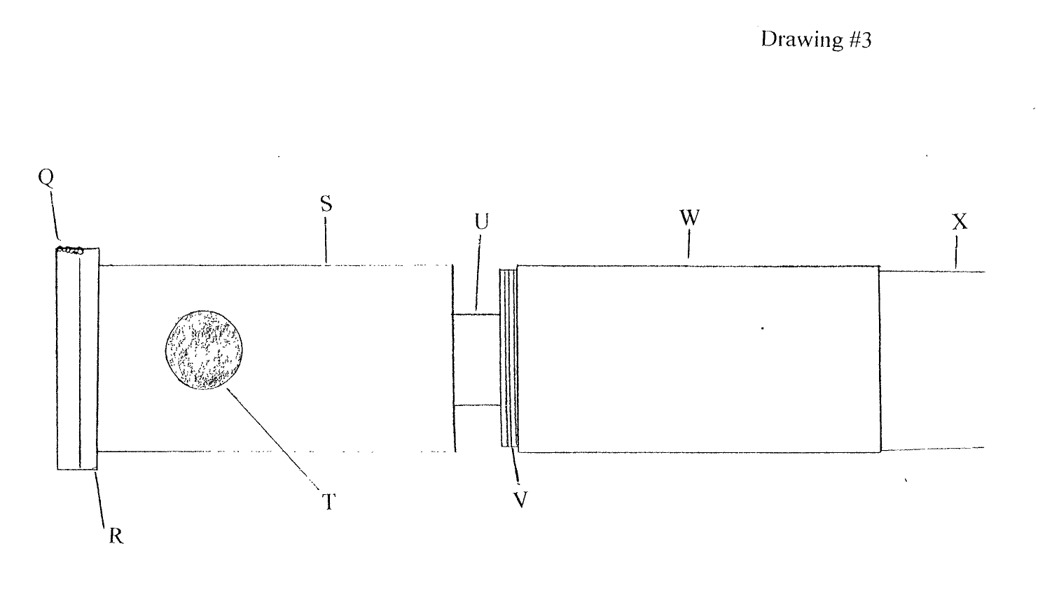

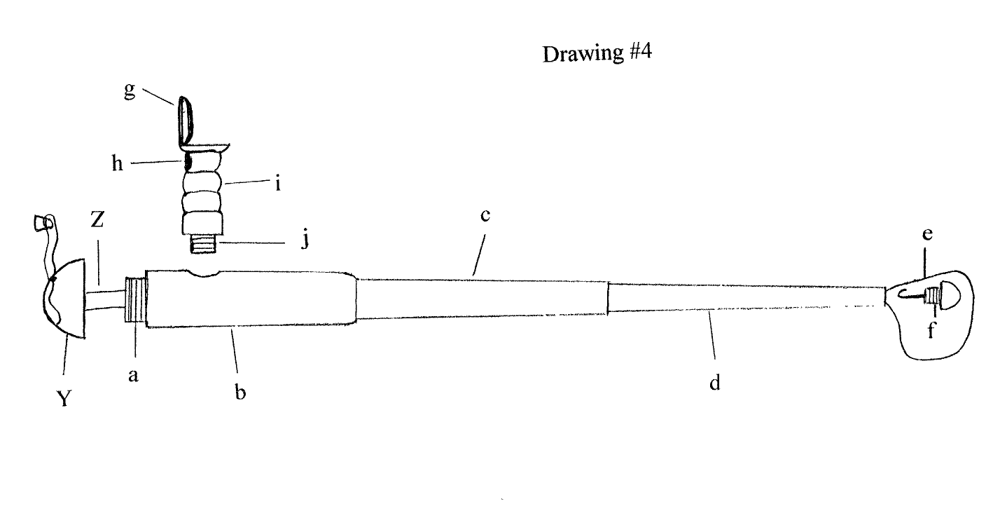

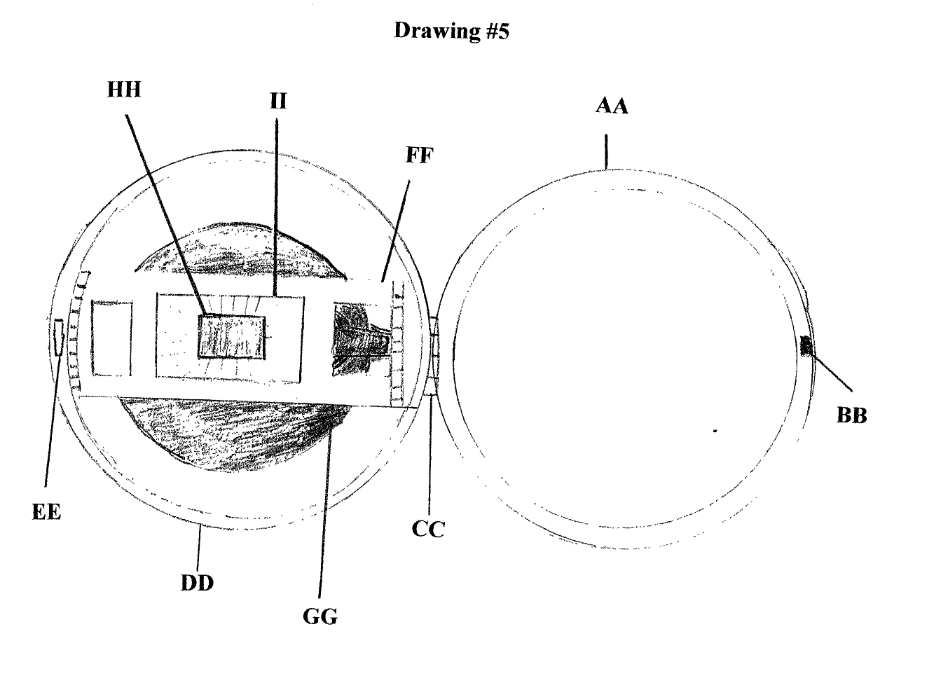

The Mongoose is a police/security (self-defense) collapsible baton, with the addition of a snake/animal catching device, which is incorporated inside it.

The baton comprises of; a handle portion, which incorporates a tensile wire type (or other substance) of line and acts as a reel/puller; a middle telescoping section; and an end telescoping section, which allows the wire to protrude out in a loop-like fashion, for capturing snakes/animals. The handle portion of the baton will allow for easy opening (expanding the sections) operation by either an inertia type of force utilized by the operator, or by a spring loaded mechanism. This will allow for the speedy application for self-defense or animal/reptile capture. The proximal portion will also allow for the operation of the tensile wire (tightening and releasing, which can be done in a variety of fashions, as depicted by the drawings.). The distal telescoping section of the baton will have a protruding tip member which will either detach or allow the tensile loop to exit the baton for its intended use (capturing reptiles/animals).

### DRAWING #1

This is a view of the mongoose's most basic form. Other drawings will depict more advanced methods of performing the same task.

A. Is the end-cap portion, which once unthreaded acts as a line puller. This is the Mongooses basic form, more advanced pullers that utilize reels may also be adapted.

B. Is the “doubled” line itself attached to the end-cap and running through the hollow baton.

C. Is the threaded portion of the handle that allows the end-cap to seat against the handle.

D. Is the handle portion that is coated with a non-slip grip foam rubber (or other substance).

E. Is the proximal telescoping section, which is tapered for ease in operation.

F. Is the distal telescoping section, which is also tapered for ease in operation, and is threaded with a female joint at its distal tip.

G. Is the line itself, protruding past the distal tip of the last telescoping section, and forms a loop, and travels back through the hollow baton to the end-cap.

H. Is the distal cap, which is threaded with a male joint, and is used to cover the distal tip of the last telescoping section, when mongoose is not in operation.

### DRAWING 190 2

This drawing shows the underside of the end-cap, in either its basic form or with pepper spray incorporated into it (as shown in drawing 3).

I. Is the hinged detachable tactical mirror. Once opened it allows for depression of the built in pepper spray, and once detached, it is fitted into the distal tip of the last telescoping section for use in tactical situations (seeing around corners/under cars).

J. Is the line spool, which holds the mongoose line and keeps it out of the way of the normal baton operations.

K. Is the beginning of the line (single strand).

L. Is the tie down for the beginning of the line.

M. Is the female slot that houses the end piece of line, when the mongoose is in operation.

N. Is the male part to “M”. It is attached to the end piece of line “p”, and in addition to being a removable slot joint, acts as a weight for the line, to allow ease in feeding the line through the hollow baton.

O. Is the female grooves/joint that allows the end-cap to seat against the handle portion.

P. Is the end of the mongoose's line, which is attached to “N”.

### DRAWING #3

Is a view of the baton with pepper spray and tactical mirror incorporated into the line puller mechanism.

Q. Is the closed tactical mirror end-cap.

R. Is the semi-fixed base of the tactical mirror, which allows the mirror to snap closed, once shut, and keeps the pepper spray in place, while allowing for the pepper spray's release button to protrude slightly through it.

S. Is the hollow proximal portion of the handle that houses the pepper spray. It is coated with a non-slip grip material.

T. Is the opening for the released pepper spray.

U. Is the mongoose line itself, running down the baton and back again.

V. Is the male threads, that allow section “S” to seat against section “W”,

W. Is the Distal portion of the handle. It is hollow for the running of the line cord and it also houses the two telescoping section when they are not deployed. It is also coated with a non-slip grip foam rubber.

X. Is the Proximal telescoping section.

### DRAWING #4

This is a drawing of the Mongoose in PR24 side handle form. It operates similar to the basic Mongoose, however in PR24 style. It utilizes a reel puller instead of knob puller, making it a deluxe version. It will also be available in a more basic form.

Y. Is the proximal end-cap reel that operates the line, and is fitted with a collapsible contoured handle, making it snag free when not in use.

Z. Is the line itself running down the length of the baton, and back again.

a. Is the thread connection for attaching the proximal reel end-cap to the baton.

b. Is the proximal section of the baton, which houses the two telescoping sections.

c. Is the First telescoping section. It is tapered for ease in opening.

d. Is the second telescoping section. It is tapered for ease in opening.

e. Is the Mongoose line, which exits the distal telescoping section, and reenters forming a loop, for capturing snakes/reptiles.

f. Is the distal end-cap. It is threaded, so that it can be removes for the deployment of the Mongoose line. It is also fitted with a hook, to aid in retrieving the line.

g. Is the hinged detachable tactical mirror, which also acts as a cover for the pepper spray release button.

h. Is the opening for the released pepper spray.

i. Is the PR24 side handle. It is grooved to aid in maintaining a grip.

j. Is the joint attachment for the PR24 side handle. It may be threaded (as shown), fitted with a quick release, permanently fixed, or allowed to swivel (all may be produced as different models).

I claim:

1. A self-defense baton containing an animal/reptile catcher within, and:
a) A non-slip handle portion, containing a tensile wire device.
b) The option of either manually or mechanically via a spring mechanism, expanding the telescoping sections.
c) Telescoping sections that allow for an extended reach for the various uses of the device.
d) A distal tip member, that allows for the passage of the reptile/animal catching mechanism-line.
e) Means for closing the device, via either physical force or by way of a release button/mechanism.
f) The telescoping sections may be tapered from a larger end to a smaller end, for ease in use.
g) The use of pepper spray to be incorporated into the devise.
h) The use of a hinged detachable tactical mirror to be incorporated into the devise.
